(19) United States
(12) Patent Application Publication
(10) Pub. No.: US 2010/0071046 A1
(43) Pub. Date: Mar. 18, 2010

(54) Method and System for Enabling Access to a Web Service Provider Through Login Based Badges Embedded in a Third Party Site

(75) Inventors: Sidharta Seethana, Bangalore (IN); Neelesh Dani, Bangalore (IN)

Correspondence Address: BAKER BOTTS L.L.P., 2001 ROSS AVENUE, 6TH FLOOR, DALLAS, TX, 75201, US

(73) Assignee: YAHOO! INC., Sunnyvale, CA (US)

(21) Appl. No.: 12/212,581

(22) Filed: Sep. 17, 2008

(51) Int. Cl. H04L 9/32; G06F 21/00

(52) U.S. Cl. 726/9

(57) ABSTRACT

A system and method which may allow a user to login a web service provider from a third party site without leaking the user's login information to the third party site. A service request interceptor may authenticate the third party site to make sure that a service request is from a third party site registered with the web service provider or its associated sites, and then instruct a badging server to send an HTML markup to the third party site to enable a login page of the web service provider to be displayed as a pop up window, outside of the third party site. Before sending the instructions to the badging server, the service request interceptor may check whether the user has already logged in the web service provider, and authenticate a user to make sure that the user is registered with the web service provider. Since the user may interact with the web service provider directly, the third party site may be bypassed and users' credentials may be better protected.

### BACKGROUND

1. Field of the Invention

The present invention relates to the use of Internet badges which enable content from a badge provider site to be displayed on a third party site.

2. Description of Related Art

Internet badges are often used by web service providers to collect information from or display information on third party sites. The web service provider could provide the badge or the badge may be built by a badge provider who uses the web service to store information provided through the badge or display information in the badge provided by the web service. In one example, Yahoo! Shopping may list tens of thousands of third party on-line shopping sites, and a user may be directed to one of such third party sites if he is interested in purchasing something from a third party site. Yahoo! Shopping may only want to list third party sites providing good services, and may want to collect user feedback to rate the third party sites. Yahoo! Shopping may collect such information through badges embedded in the third party sites, and may also display the current overall rating of a third party site and/or user ratings, if users have already rated the third party site through the same or different badge.

FIG. 1 illustrates a currently available system for using a login based badge embedded in a third party site to collect information. As shown, a login based badge 102 from a web service provider 101 (e.g., a rating service site associated with Yahoo! or Yahoo! Shopping) may be embedded in a third party site 103 (e.g., my.domain.com) through a badging server 104 and a computer network 105, so as to collect users' comments on the third party site 103. The badging server 104 may provide a visual interface (i.e., the badge 102) to the web service provider 101 that can be embedded in the third party site 103. The login based badge 102 may be displayed on the third party site 103, e.g., after a user has used the service of the third party site 103. When a user types in his login information for the rating service site through the badge 102, the badge 102 may collect the login information through the third party site 103 and then either passes this information to the badging server 104 which in turn may route the login information to the web service provider 101 or the badge 102 may directly contact the web service provider 101 for the purpose of storing/displaying information. If the user is authenticated, he may be directed from the third party site to the web service provider 101 which displays a number of questions for rating the third party site 103, and the badge 102 may communicate with the web service provider 101 directly for saving and displaying information.

Since users' login information for the rating service site is collected through the third party site, there may be a question of trust on the third party site from the users' perspective, and there may be chances of misuse of user credentials given through the third party site. Therefore, it may be desirable to provide a system and method which may allow a web service provider to collect user input from a third party site via a login based badge while keeping users' credentials confidential.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates a currently available system for using a login based badge embedded in a third party site to collect information.

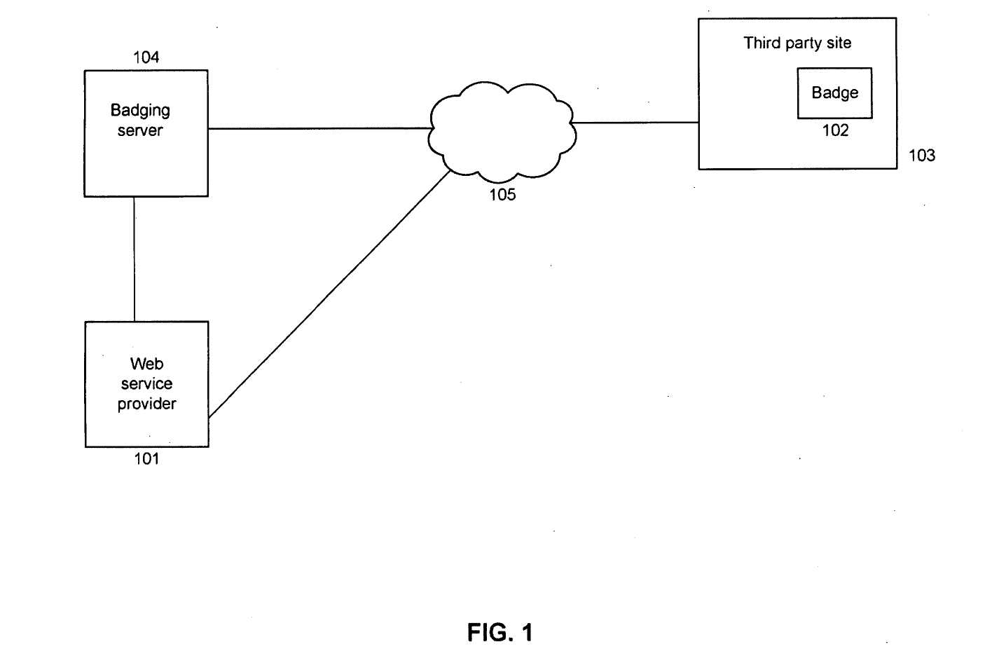

FIG. 2 illustrates a system for enabling access to a web service provider through a badge embedded in a third party site according to one embodiment of the present invention.

FIG. 3A illustrates a flow chart of a method for enabling access to a web service provider through a badge embedded in a third party site according to one embodiment of the present invention.

FIG. 3B illustrates a flow chart of a method for enabling access to a web service provider through a badge embedded in a third party site according to one embodiment of the present invention.

FIG. 4 illustrates a flow chart of a method for enabling access to a web service provider through a badge embedded in a third party site according to one embodiment of the present invention.

### DETAILED DESCRIPTION

The present invention provides a system and method which may allow a user to login to a web service provider from a third party site without leaking the user's login information to the third party site. A service request interceptor may authenticate the third party site to make sure that a service request is from a third party site registered with the web service provider or its associated sites, and then instruct a badging server to send an HTML markup to the third party site to enable a login page of the web service provider to be displayed as a pop up window, outside of the third party site. Before sending the instructions to the badging server, the service request interceptor may check whether the user has already logged into the web service provider, and authenticate a user to make sure that the user is registered with the web service provider. Since the user may interact with the web service provider directly, the third party site may be bypassed and users' credentials may be better protected. Advantages of the present invention will become apparent from the following detailed description.

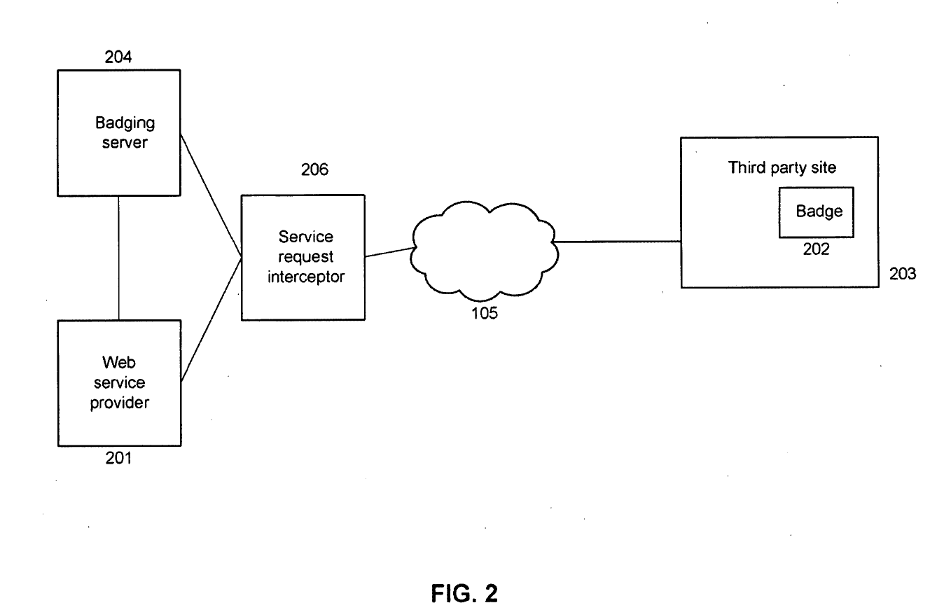

FIG. 2 illustrates a system for enabling access to a web service provider through a badge embedded in a third party site according to one embodiment of the present invention. The exemplary system may be used by a web service provider 201 (e.g., a rating service site) to collect user inputs via a login based badge 202 embedded in a third party site 203 (e.g., my.domain.com listed on Yahoo! Small Business) to rate services of the third party sites. The rating service site may be a part of another web service provider, e.g., Yahoo!, Yahoo! Shopping or Yahoo! Small Business, or be associated with the another web service provider. The rating service site and its associated sites may share user login information, and accordingly may be regarded as one badge provider.

The third party site 203 may embed the login based badge 202 in its web pages. The badging server 204 may send an HTML markup to enable the login based badge 202 to be incorporated in the third party site 203. The login based badge 202 may be displayed after a user has used the service provided by the third party site 203. Upon instructions from a service request interceptor 206, the badging server 204 may send an HTML markup to the third party site 203 to enable the login page for the rating service site to be displayed as a pop up window, outside of the third party site 203.

The service request interceptor 206 may send instructions to the badging server 204 for sending the HTML markup of the login page for the rating service site after determining that a user is interested in rating the service of the third party site 203. The service request interceptor 206 may determine that a user is interested in rating the third party site 203 if there is an input on the login based badge 202 displayed on the third party site 203. The user input may be, e.g., a click on the login based badge 202, or a letter typed in a window on the login based badge 202.

Before sending the instructions to the badging server 204, the service request interceptor 206 may authenticate the third party site to make sure that a rating request is from a third party site registered with the rating service site. In one embodiment, a third party site may need to register with the web service provider to use the login based badge, and a secret may be shared between the third party site and the web service provider. When there is a user input on the login based badge 202 displayed on the third party site 203, a rating request may be sent from the third party site 203 to the rating service site. A signature based on the shared secret may be generated at the third party site 203 and sent together with the rating request. The service request interceptor 206 may intercept the rating request and authenticate the third party site 203 through signature verification based on shared secrets. The service request interceptor 206 may send instructions to the badging server 204 when the third party site 203 is registered with the rating service site, and may inform the user if the third party site 203 is not registered with rating service site.

Before sending the instructions to the badging server 204, the service request interceptor 206 may check whether the user has already logged into the rating service site, and may send the instructions to the badging server 204 when the user is not logged into the rating service site.

Before sending the instructions to the badging server 204, the service request interceptor 206 may further authenticate a user to make sure that the user is registered with the rating service site. The user authentication may be based on verification of the user's login information.

Before sending the instructions to the badging server 204, the service request interceptor 206 may further determine whether the user has already rated the third party site 203, and may send the instructions when the user has not rated the third party site 203.

The service request interceptor 206 may direct a user to the rating service site after authenticating the third party site and/or the user, so that the user may provide his rating inputs there.

The service request interceptor 206 may be a plug-in at the web service provider 201.

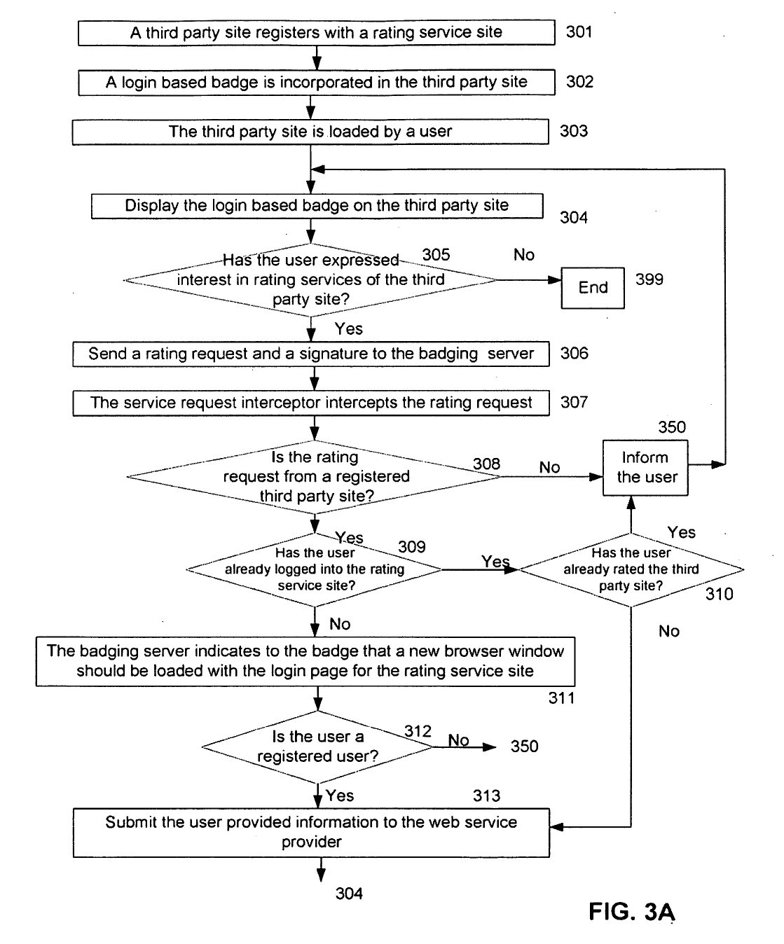

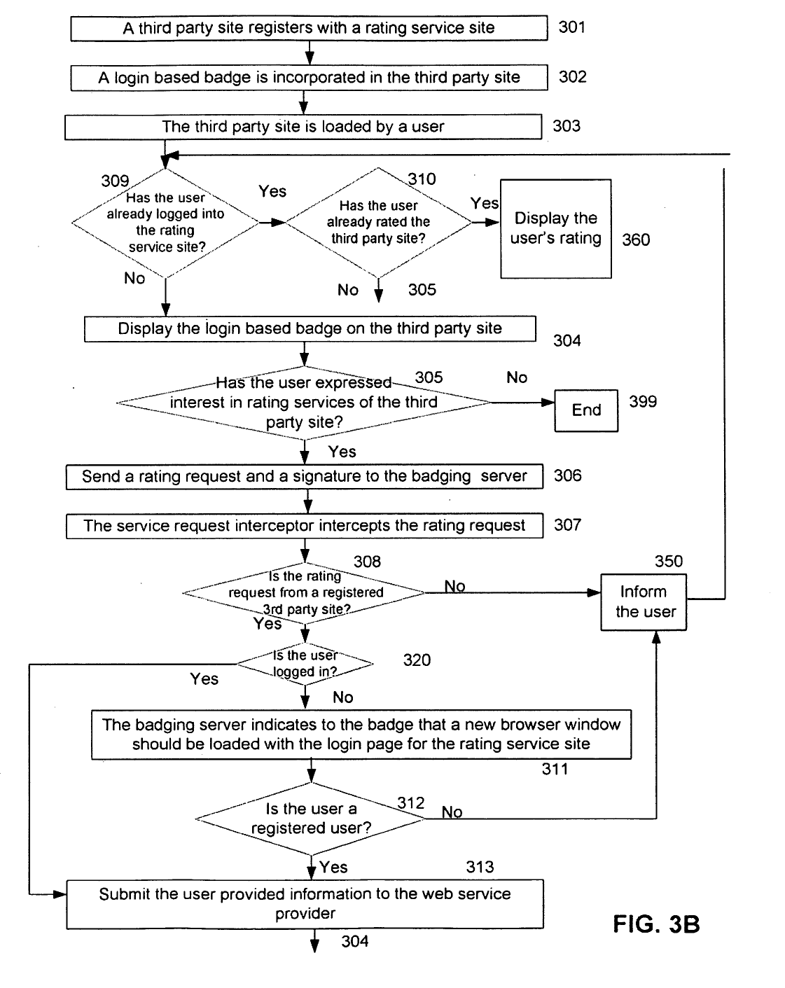

FIG. 3A illustrates a flow chart of a method for enabling access to a web service provider through a badge embedded in a third party site according to one embodiment of the present invention. The method may be used in the system shown in FIG. 2. The login based badge 202 may be embedded in the third party site 203 (e.g., my.domain.com listed on Yahoo! Small Business) via the badging server 204, so that the web service provider 201, a rating service site in this example, may collect user feedback on services of the third party site 203.

At 301, the third party site 203 may register with the rating service site, or its associated sites, and a shared secret may be issued to the third party site 203. The shared secret may be used by the third party site 203 to generate a signature that may be sent along with a rating request to the rating service site for authenticating the third party site 203. The secret may be saved in a server running the third party site 203.

At 302, a login based badge may be incorporated in the third party site 203. The third party site 203 may configure the login based badge to harmonize it with other parts of the third party site 203, and add the login based badge 202 to the third party site 203.

At 303, the third party site 203 may be loaded in a browser upon a user's request.

At 304, the login based badge 202 may be displayed on the third party site 203. In one embodiment, the login based badge 202 may be displayed on the third party site 203 after a user has used the service provided by the third party site 203. In one embodiment, when the user requests for the third party site (where the badge is embedded), the third party site may be loaded in the user's browser. After the badge is loaded, user may click on the badge, and the rating request may be sent by the user's browser to the badging server 204.

At 305, the service request interceptor 206 may determine whether the user has indicated that he is interested in rating services of the third party site 203. In one embodiment, the service request interceptor 206 may detect whether there is any input on the login based badge 202. If the user clicks on the login based badge 202 or type in a window on the login based badge 202, the service request interceptor 206 may decide that the user is interested in rating services of the third party site 203.

If the user is not interested in rating services of the third party site 203, the procedure may end at 399. Otherwise, at 306, the third party site 203 may send a rating request to the badging server 204 along with a signature generated at the third party site server based on the shared secret. The rating request may include identification of the third party site, the target of rating, a time stamp and a signature. The signature may be generated using javascript or PHP code. In one example, the signature may be:
Signature=8e7cab296d86242d385ab12d91311166,
   and the rating request may be:
   http://api.ratings.yahoo.com/Widget?domain=my.domain.com&target=my_service&ts=11852723272&sig=8e7cab296d86242d385ab12d91311166

At 307, the rating request from the user's browser to the badging server 204 may be intercepted by the service request interceptor 206.

At 308, the service request interceptor 206 may verify the signature to make sure that the rating request is from a third party site registered with the rating service site. In one embodiment, the service request interceptor 206 may use parameters in the rating request (e.g., the identification of the third party site 203) and the share secret saved at the web service provider 201 to generate a signature again, and compare the generated signature and the signature received together with the rating request. If the generated signature and the received signature do not match each other, the service request interceptor 206 may inform the user at 350, and the procedure may return to 304. Otherwise, the service request interceptor 206 may decide that the third party site 203 is a registered third party site, and the procedure may proceed to 309. It should be understood that 308 may be performed earlier in the procedure, e.g., before the badge is loaded at 304 to ensure that a registered site is requesting for the badge.

At 309, the service request interceptor 206 may determine whether the user has already logged into the rating service site. If the user has already logged into the rating service site, at 310, the service request interceptor 206 may determine whether the user has already rated the third party site 203. If the user has already rated the third party site 203, he may be so informed at 350 and the procedure may return to 304. In one embodiment, the user's rating may be displayed. If the user has not rated the third party site 203 yet, the procedure may proceed to 313, which will be described below.

If the user has not logged in the rating service site yet, a login page for the web service provider 201, the rating service site in this embodiment, may be displayed at 311. In one embodiment, the service request interceptor 206 may pass the user's login status to the badging server 204 or the web service provider 201, which may then inform the badge 202 that the user has not logged in. The badging server 204 may indicate to the badge 202 that a new browser window should be loaded with the login page for the rating service site. The badge 202 may receive an HTML markup from the badging server 204 and cause a login page for the rating service site to be loaded in a new window, asking the user to enter his credentials. In one embodiment, the login page for the rating service site may be displayed as a pop-up window. Consequently, the user may bypass the third party site 203 and provide his login information directly to the rating service site. The user may clearly see from the login page loaded or the URL displayed that he is entering his credentials only at the web service provider site.

At 312, the service request interceptor 206 may validate the user by checking his login information and cookies. If the user is not a registered user, he may be so informed at 350, and the procedure may return to 304. If the user is a registered user, at 313, the service request interceptor 206 may direct the user to the rating service site and submit the user provided information thereto. In one embodiment, the service request interceptor 206 may also receive the user's rating inputs and forward the rating inputs to the web service provider 201. The procedure may then return to 304.

Although the described embodiments relate to rating the service of a third party site, the system and method described may be used to rate a product on a third party site, or may be in any situation where one web site embeds a login based badge in a second web site and collects user credentials via the login based badge. In such cases, embodiments of the present invention may ensure that credentials are supplied by the user only at the service site and not directly in the login based badge.”

It should be understood that the flow chart in FIG. 3A is only an example, and is not used to limit the sequence of the steps. In one embodiment, 309 and 310 may be performed when the badge is first displayed, e.g., before 304, as shown in FIG. 3B. After the third party site 203 is loaded in a browser upon a user's request at 303, the service request interceptor 206 may determine whether the user has already logged into the rating service site 201. If not, the process may proceed to 304.

If the user has already logged into the rating service site 201, at 310, the service request interceptor 206 may determine whether the user has already rated the third party site 203. If yes, the user's rating may be displayed at 360. If the user has not rated the third party site yet, the process may proceed to 305.

In one embodiment, 305 may be performed after 308, and may come either if the user has not logged in or if the user has logged in but has not yet rated the service.

In one embodiment, after 308, the service request interceptor 206 may determine whether the user has already logged into the rating service site 201 at 320. If the user has not logged in, the process may proceed to 311. Otherwise, the process may proceed to 313.

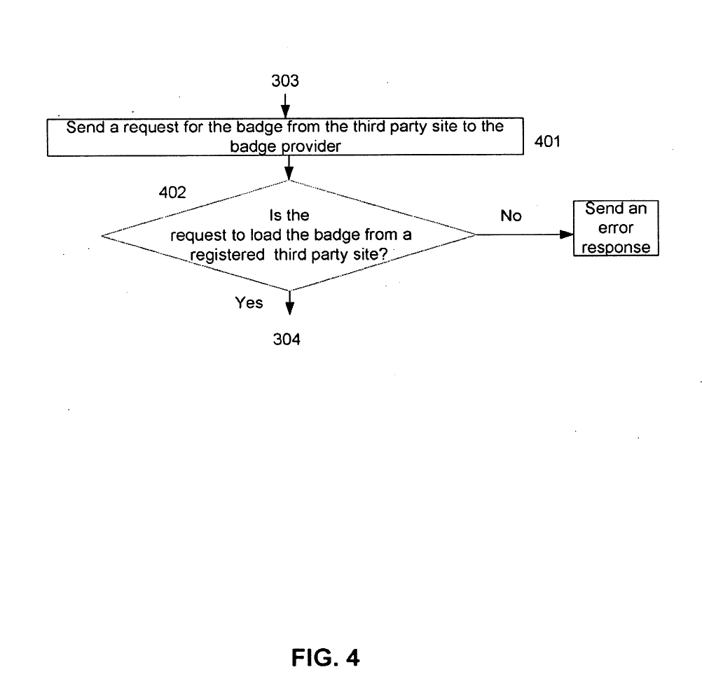

FIG. 4 illustrates a flow chart of a method for displaying a login based badge according to one embodiment of the present invention. The method may be used in the system shown in FIG. 2, and may be performed between 303 and 304 in the process shown in FIG. 3A. As shown, at 401, a request for a login based badge may be sent from the third party site to the badge provider, or the rating service provider 201 in this example. At 402, the badging server 204 may determine whether the request to load the badge is from a registered third party site. If yes, the badge may be sent to the third party site and displayed there at 304. Otherwise, the badging server 204 may send an error response indicating that the badge is being loaded by an unauthorized site. The method may also be performed between 303 and 309 in the process shown in FIG. 3B.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of enabling access to a web service provider from a third party site through a login based badge, wherein the login based badge is embedded in the third party site, the method comprising:
intercepting a service request from the third party site to the web service provider;
authenticating the third party site; and
displaying a login page of the web service provider, wherein the login page is displayed independent of the third party site.

2. The method of claim 1, further comprising: determining whether a user is interested in the service provided by the web service provider.

3. The method of claim 2, further comprising: determining that a user is interested in the service provided by the web service provider if the login based badge is clicked on.

4. The method of claim 2, further comprising: determining that a user is interested in the service provided by the web service provider if the login based badge is typed on.

5. The method of claim 1, wherein the third party site is authenticated through signature verification.

6. The method of claim 5, wherein the signature is generated based on a secret shared between the third party site and the web service provider.

7. The method of claim 1, further comprising: determining whether a user has already logged into the web service provider, and displaying the login page of the web service provider when the user has not logged in.

8. The method of claim 1, further comprising: receiving login information of a user at the login page and determining whether the user is a registered user based on the login information.

9. The method of claim 1, further comprising: displaying a web page of the web service provider.

10. The method of claim 1, wherein the web service provider receives user ratings on services provided by the third party site.

11. The method of claim 10, further comprising: determining whether a user has already rated the third party site.

12. The method of claim 11, further comprising: displaying the user's ratings if the user has already rated the third party site.

13. The method of claim 1, further comprising: sending an HTML markup to the third party site to enable displaying of the login page of the web service provider.

14. The method of claim 1, wherein the login page of the web service provider is displayed as a pop-up window.

15. A system for enabling access to a web service provider from a third party site through a login based badge, wherein the login based badge is embedded in the third party site, the system comprising:
a badging server for embedding the login based badge in the third party site; and
a service request interceptor, coupled between the badging server and the web service provider, intercepting a service request from the third party site to the web service provider and authenticating the third party site.

16. The system of claim 15, wherein the badging server sends an HTML markup to the third party site to enable displaying of the login page of the web service provider in response to instructions from the service request interceptor.

17. The system of claim 15, wherein the service request interceptor authenticates the third party site through signature verification.

18. A computer program product comprising a computer-readable medium having instructions which, when performed by a computer, perform a method of enabling access to a web service provider from a third party site through a login based badge, wherein the login based badge is embedded in the third party site, the method comprising:
intercepting a service request from the third party site to the web service provider;
authenticating the third party site; and
displaying a login page of the web service provider, wherein the login page is displayed independent of the third party site.

19. The computer program product of claim 18, wherein the third party site is authenticated through signature verification.

20. The computer program product of claim 18, wherein the method further comprises: determining whether a user has already logged into the web service provider, and displaying the login page of the web service provider when the user has not logged in.

21. The computer program product of claim 18, wherein the method further comprises: sending an HTML markup to the third party site to enable displaying of the login page of the web service provider.
